(19) United States
(12) Patent Application Publication
(10) Pub. No.: US 2019/0180491 A1
(43) Pub. Date: Jun. 13, 2019

(54) Automated Animation and Filmmaking

(71) Applicant: Marwan Hassan, Fremont, CA (US)

(72) Inventor: Marwan Hassan, Fremont, CA (US)

(73) Assignee: Marwan Hassan, Fremont, CA (US)

(21) Appl. No.: 16/211,904

(22) Filed: Dec. 6, 2018

Related U.S. Application Data
(60) Provisional application No. 62/597,386, filed on Dec. 11, 2017.

(51) Int. Cl. G06T 13/40; G06K 9/00; G06T 17/10; G06K 9/62; G06N 3/08

(52) U.S. Cl. CPC G06T 13/40; G06K 9/00624; G06N 3/08; G06K 9/6217; G06T 17/10

(57) ABSTRACT

A method is disclosed for automating computer animation. The method automatically converts 2D drawings of objects into 3D models of the objects. The 3D objects start to automatically behave or move relative to each other simulating their natural behavior in real-life. Additionally, the 3D models of the objects are capable of learning from past encounters and utilizing that data to change their methods of action during the animation.

### CROSS-REFERENCE TO RELATED APPLICATION

This application claims the benefits of a U.S. Provisional Patent Application No. 62/597,386, filed Dec. 11, 2017, titled “Automated Animation and Filmmaking”.

### BACKGROUND

Computer animation is the process of creating the illusion of motion by displaying successive digital data in frames that differ slightly from each other. It mainly requires animators specialized in 2D or 3D animation techniques. 2D animation techniques tend to focus on image manipulation. 3D animation techniques usually build virtual worlds in which characters and objects move or interact to create images that appear real to the viewer. 2D animation is created or edited on a computer using 2D bitmap graphics. 3D animation is digitally modeled and manipulated by an animator on the computer display. The animator usually starts by creating a 3D polygon mesh to manipulate. A mesh typically includes numerous vertices that are connected by edges and faces, giving the appearance of form to a 3D object or 3D environment. This includes various software applications such as MAYA, 3DS MAX or the like. Other techniques apply mathematical functions such as gravity, particle simulations, or fire and water simulations. These techniques fall under the category of 3D dynamics animation that serves various purposes or applications.

3D animation has gained popularity as a form of unique production of filmmaking. The main disadvantages of animated films are its extremely labor-intensive work, high cost, and the lengthy time needed to create realistic scenes. Until now, there has been no automated method of 3D animation that can reduce the labor, cost and time of filmmaking. If such an automated method is developed, cost, efforts and time related to filmmaking will be reduced. Additionally, non-designers will be able to simply execute their creative ideas without the need to learn or use complex software applications. In other words, the entire industry of 3D animation or filmmaking will be dramatically improved which impacts various entertainment, educational, gaming, and industrial applications.

### SUMMARY

The present invention discloses a method for automating the creation of computer animation, therefor reducing the cost, time and efforts spent on filmmaking. For example, according to one embodiment, a user can draw a freehand sketch of a 3D environment including various objects or living creatures, and the 3D models of the objects and living creatures are automatically created in real time on the computer display. The 3D objects and living creatures then start to move, behaving as if they are real-life objects or living creatures. For example, a freehand sketch of a scene comprised of a car and road automatically turns the scene into a 3D animation presenting the 3D model of the car moving on the road. The car drives on the road as if operated by a human in an intelligent manner. If a user then draws a freehand sketch of a mountain with a big rock located on the top of the mountain, a 3D model of the mountain and rock are automatically re-created on the computer display. The automated 3D animation shows the rock rolling down from the top of the mountain. When a car, road, mountain and rock are drawn in a single scene of a freehand sketch, the automated 3D animation simultaneously recreates their natural motion. For example, if the road intersects with the rolling path of the rock, then the rock might hit and crash into the car.

According to another embodiment, to achieve the aforementioned 3D animation, the method of the present invention is comprised of successive technical steps. The first step is to receive a graphical representation of a plurality of objects. The graphical representation of the objects can be in the form of a freehand sketch or drawing. A computer program is used to analyze the graphical representation and identify the objects contained in the freehand or drawing. After that, another computer program automatically creates a 3D model for each object identified. Upon identification of the objects, a database is accessed to determine the movement or behavior of each object relative to other objects. For example, the database of a car may indicate that the car can move on the road and cannot move on the mountain. Also, the car database may indicate that if a rock hits a car while the car is speeding or while the rock is falling from the mountain then the car will get crushed.

In one embodiment, the objects are classified in the database as inanimate, machines, or living creatures. Inanimate are lifeless objects such as mountains or rocks. Machines are any vehicle, apparatus, or device used in the animation. Living creatures are humans, animals, birds or the like. The database of each inanimate, machine or living creature differs to suit and recreate realistic behavior befitting each object, as will be subsequently described.

### BRIEF DESCRIPTION OF DRAWINGS

FIG. 1 illustrates a first frame of an example of an automated animation showing a lion attacking a deer.

FIG. 2 illustrates a second frame of the automated animation showing the lion attacking the deer.

FIG. 3 illustrates a third frame of the automated animation showing the lion attacking the deer.

FIG. 4 illustrates a fourth frame of the automated animation showing the lion attacking the deer.

FIG. 5 illustrates a fifth frame of the automated animation showing the lion attacking the deer.

FIG. 6 illustrates the six and last frame of the automated animation showing the lion attacking the deer.

FIG. 7 is a block diagram illustrating the process of the present invention according to one embodiment.

### DETAILED DESCRIPTION

The computer animation mainly depends on the movement of the objects that appear on the computer display. To automate, the animation rules must be set to manipulate the objects' movement during the animation. Generally, the objects that appear in the animation can be classified into three groups or classes. The first class of animation objects is the inanimate or lifeless objects that follow the rules of physics or dynamics during their movement. For example, a rolling rock from a mountain top to the ground can be automatically simulated on the computer display using the physics rules of dynamics. This includes the use of the dynamic equations that represent the relationship between the distance, velocity, acceleration, time, mass, power, energy, gravity or the like. It is similar to modern 3D virtual physics labs that simulate the movement of inanimate objects in different circumstances or 3D environments on a computer display.

The second class of animation objects are machines that have a certain mode of operation. For example, when a car appears in a 3D animation, it is expected to move on roads and stop upon reaching the borders of the mountains, unless a mountain has a road. This simple description of the car's movement is what the car database uses to determine the car's behavior regarding roads or mountains which appear with the car in the same graphical representation. In one embodiment, the database includes information describing the speed of the car on different types of grounds such as asphalt roads, desert sands or mold. All such rules or conditions can be programmed to control the movement of the car based on the recognition of the type of the ground that appears with the car in the same graphical representation. Additionally, according to the dynamics rules, the slope of the ground upon which the car is moving affects the car's speed. The slope can be mathematically calculated by detecting the road dimensions or contour lines that appear in the 3D model of the ground or scene.

The third class of animation objects are living creatures or living objects such as humans, animals, birds, or the like. The movement of living creatures in the animation is determined by three factors. The first factor is the desires of the living creatures which are a list of actions a living creature tends to perform to simulate their real-life desires. For example, in an animation, the first desire of a lion in a database could be moving or relocating. Accordingly, once a freehand sketch of a lion is drawn, the 3D model of the lion will start to move in the animation. In this case, the movement of the lion will be in random directions, and the speed of the movement will be determined in the database by the type of ground the lion is moving on. A second desire of the lion in a database could be attacking other animals. In this case, once a lion and deer are located in the same animation, the lion attacks the deer by running towards her. The database then describes the speed of the lion's running or movement, in addition to the way he moves or runs. On the other hand, the desires of the deer, in the database, include escaping from the lions; which makes the deer runs away from the lion. Also, the deer's database includes the running speed of the deer when escaping from the lion, or in general when running for different reasons. However, since each desire is described with a type or speed of movement, accordingly, such automated animation can be programmed or calculated using mathematical equations.

The second factor of controlling the animation of living creatures or living objects is the virtual vision which allows a living creature to virtually see and recognize the identity of inanimate, machines, or other living creatures. This recognition ability determines which data from the database used in different situations or circumstances. For example, when the virtual vision of a 3D model of a lion recognizes the identity of a ground, lake, and deer, the lion will move on the ground, avoid walking in the lake, and attack the deer. These types of actions are based on the virtual vision of the lion that recognizes the identity of the ground, lake and deer in the scene or 3D environment. In other words, once the lion's virtual vision identifies the ground, lake and deer, the database of the lion's desires is checked to determine the behavior of the lion towards the ground, lake and deer. Generally, the virtual vision functions as a virtual eye for each 3D model of a living creature. This virtual eye can be associated with certain capabilities to simulate the natural vision of each living creature in real-life. This includes the distance of view, angle of view, and height of view which differ from a living creature to another. For example, in an automated simulation of an eagle the distance of view can be 300 foot, the angle of view can be 270 degrees, and the height of view depends on the distance between the eagle's eyes and the ground during his flying. This will allow the eagle to see better than other living creatures such as humans or animals. For example, the sight line of humans and birds is blocked by various objects located on the ground while these objects do not block the line of sight of the eagle during his flying.

The third factor of controlling the animation of living creatures is the virtual brain which allows a living creature to make decisions based on the database of the desires and the data collected by the virtual vision. In other words, the virtual brain is a computer program with certain capabilities assigned to each living creature to simulate the capabilities of the living creature's brain in real-life. This computer program can manage the movement of the object according to other inanimate, machines, or living creatures located in the same animation. For example, when a lion and deer are drawn in the same graphical representation or animation, the virtual vision of the lion and deer scans their respective field of view based on the parameters of their virtual vision. Once the lion sees the deer, he desires to attack and so starts to run towards her. This is mainly managed by the computer program tied to the virtual brain of the lion. In this case, the method of the present invention calculates the distance between the 3D models of the lion and deer, and determines if it fits within the limits of the lion's vision or distance of view. If it fits, then the method of the present invention moves the lion towards the deer according to the speed defined in the lion's desires database of the lion. If the sight of the lion and deer is blocked by any object such as a mountain, they behave as if they do not see one another. Generally, blocking the view between the lion and deer is achieved by drawing an imaginary line connecting the 3D models of the lion and deer then checking if this imaginary line intersects or not with other objects. If it intersects that means the lion cannot see the deer, and if it does not intersect that means the lion can see the deer.

Generally, the present invention discloses a method for animating objects located in one scene wherein the method comprising; receiving a graphical representation of a plurality of objects; recognizing the identity of each inanimate, machine or living creature located in the graphical representation; accessing a first database and second database that successively describe the movement of the 3D models of the inanimate, machines, and living creatures towards each object; and accessing a third database that describe the desires, virtual vision, and virtual brain of the living creatures. The desires are a list of actions described by the type of the creature's movement according to other objects; the virtual vision describes the ability of the creature to see and recognize the objects, and the virtual brain is a program that manages the creature's movement according to the desires and the data collected by the virtual vision.

In one embodiment, the graphical representation is in the form of a freehand sketch representing the inanimate, machines, or living creatures of the animation. In this case, the freehand sketch will be automatically converted into a 3D model representing the 3D models of the inanimate, machine, and living creature using a software program. The software program can utilize a technique similar to the techniques disclosed in the U.S. patent application Ser. No. 14/516,441. In this case, the freehand sketch can be drawn on a tablet, mobile phone, or computer display. The freehand sketch can also be drawn on a piece of paper using a pencil and the user then takes a picture of the drawing with a digital camera of a tablet or mobile phone. In another embodiment, the graphical representation is in the form of 3D models of a plurality of objects located in a single 3D environment. In this case, a software program identifies each 3D model located in the 3D environment. Such software functions by rotating each 3D model of an object and capturing its pictures with a virtual camera then comparing these pictures with a database that associates multiple pictures of each 3D model with an ID. In yet another embodiment, the freehand sketch or the 3D models of the graphical representations are manually identified by a user who associates each inanimate, machine, or living animation with an ID or name.

In another embodiment, the graphical representation is in the form of a real-life picture that includes inanimate, machines, and living creatures. In this case, a computer vision program is utilized to recognize the identity of the inanimate, machines, and living creatures located in the picture. Each identity of an object is subsequently replaced with a 3D model representing the inanimate, machines or living creatures that form the animation. If a depth sensing camera is used to take the real-life picture, then the 3D models of the inanimate, machines, and living creatures located in the picture are automatically created. This is achieved by converting the set of points cloud of each object into a 3D polygon mesh that forms the 3D model of the object, as known in the art.

In one embodiment, the first database includes the physics rules or dynamics equations that describe the movement of the animate. Accordingly, the computer system manipulates the movement of the inanimate similar to the animation of the virtual experiments of the physics lab. For example, when a rock is drawn on a steep mountain, the rock rolls down the mountain surface until reaching the ground. While the rock rolls, its speed accelerates until reaching the maximum velocity when it reaches the ground. The velocity of the rock is increased according to physics rules or dynamics equations that describe the relationship of the velocity, distance, time, acceleration and gravity. If the rock hits an object located on the ground during its roll down the mountain, the rock may keep rolling for a short or long distance according to the relative masses of the rock and object. For example, if the mass of the rock is much larger than the mass of the object, then the rock may roll for a long distance before it stops. If the mass of the rock is much smaller than the mass of the object, then the rock may completely stop or roll for a short distance before it stops.

According to one embodiment, the second database includes the operation of different types of machines that may appear in the graphical representation. This operation is described by the movement of each machine or the movement of the machine parts. For example, if the machine is a car, the second database may include the speed of the car movement on the roads located in the graphical representation. Additionally, the second database may include the behavior of the car when it gets hit by other objects such as vehicles or rocks in order to simulate the car crash that happens in real life. Also, the second database may describe the falling of the car from a mountain, or the car sinking in water, or other circumstances that can be part of the automated animations. A car falling from a mountain or sinking in water can be automatically simulated using the same dynamics equations of the inanimate, as was described previously. However, it is important to note that the car is usually driven by a human which means during the automated simulation the car will move in an intelligent manner as if driven. This driver has desires, virtual vision, and virtual brain as previously mentioned.

In one embodiment, the third database includes the desires, virtual vision, and virtual brain of the creature. The desires of the living creatures are represented by a list of actions, each of which is described by a type of movement. For example, the desires of a lion may include walking, running, jumping, or attacking. The walking, running, and jumping can be described by the lion's movement in certain speeds or manners. The attacking can be described by running towards other living creatures which appear in the animation. Generally, all actions that appear in the desires list should be described by a type of movement. Or at least, each desire should be described by actions that can be represented by movement. For example, a desire list of a male may include “love” some female, in this case, the desire “love” should be described by a type of movement or described by other actions that can be represented by movement. Such other actions can be “getting close to the female” or “looking at the female”, where these two actions can be described by the male's movement towards the female. Accordingly, once the graphical representation includes these male and female, then the 3D model of the male starts to move towards the 3D model of the female, or looks at her from time to time.

The virtual vision of the living creatures included in the third database is represented by a computer program that simulates the ability of a living creature to see and recognize the inanimate, machines, or other living creatures located in the same animation. For example, when a 3D model of a lion and deer are located on one side of a 3D model of a mountain, the lion sees the deer and moves to attack her. When the 3D model of the lion and deer are located on two opposite sides of the 3D model of the mountain, then the lion cannot see or attack the deer. To automate such lion's actions, an imaginary line is draw between the lion's eyes and the deer. If this imaginary line intersects with other objects located in between the lion and deer, the lion cannot see the deer. If the imaginary line does not intersect with any objects that means the lion can see and recognize the deer, and accordingly, the lion moves to attack the deer. In one embodiment, the imaginary line can be restricted by a certain length or distance to simulate the lion's natural vision in real-life.

The virtual brain of the living creatures included in the third database is represented by a computer program that makes the movement decisions of a living creature. These movement decisions are based on the desires list and the data collected by the virtual vision of the living creature. For example, if the desires list of a lion includes “walk” then the virtual brain moves the lion in random directions to achieve the “walk” desire. If the desire list of the lion includes “attack a deer” then the virtual brain continuously checks the data received from the virtual vision until the deer is recognized, at this moment the lion moves towards the deer to attack her.

In one embodiment, the virtual brain has different levels of intelligence to suit the natural intelligence of each living creature. This level of intelligence can be represented by the speed of processing the data of the virtual vision to achieve the desires list of the living creature. Also, the level of intelligence can be represented by the number of paths that a virtual brain can figure out before taking a decision to move in a certain direction or path. For example, for a lion to attack a deer there might be multiple paths to move from the lion's position to the deer's position. Some of these paths take different time periods than others. If the lion's intelligence is set to he high, then the computer system selects the best or shortest path to attack the deer. If the lion's intelligence is set to be low, the computer system selects the longest path to attack the deer. Of course, taking the longest path may allow the deer to escape the lion, according to her speed and the time the lion will spend to reach her position.

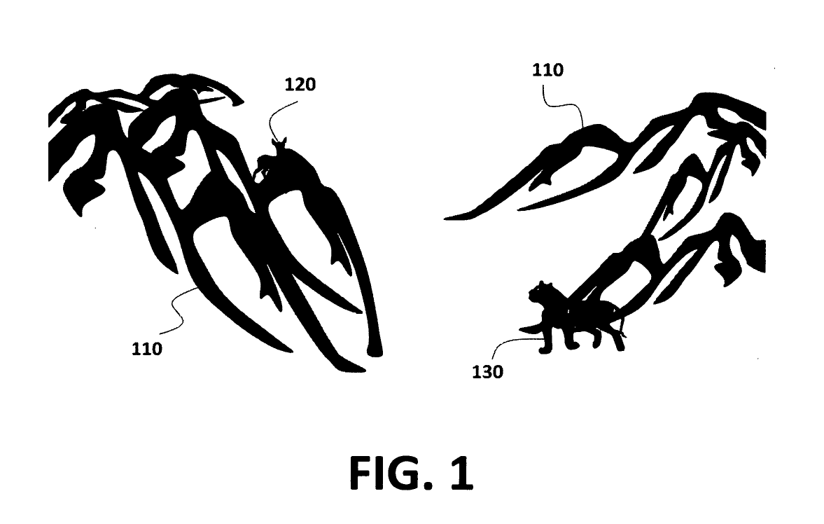

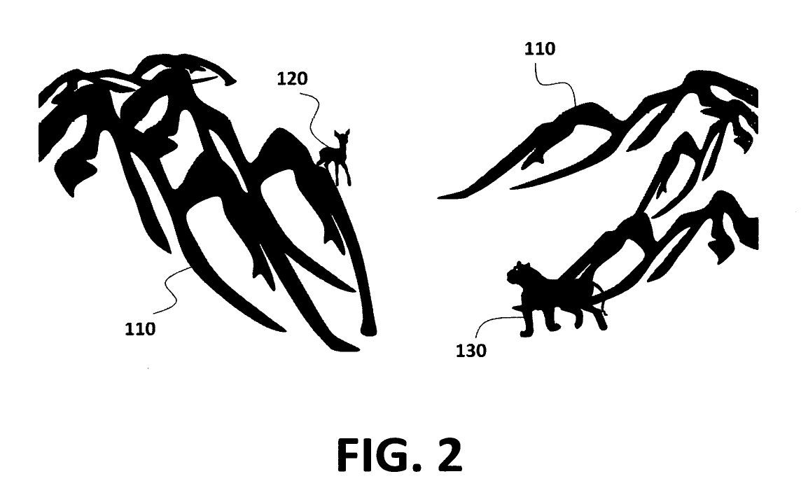

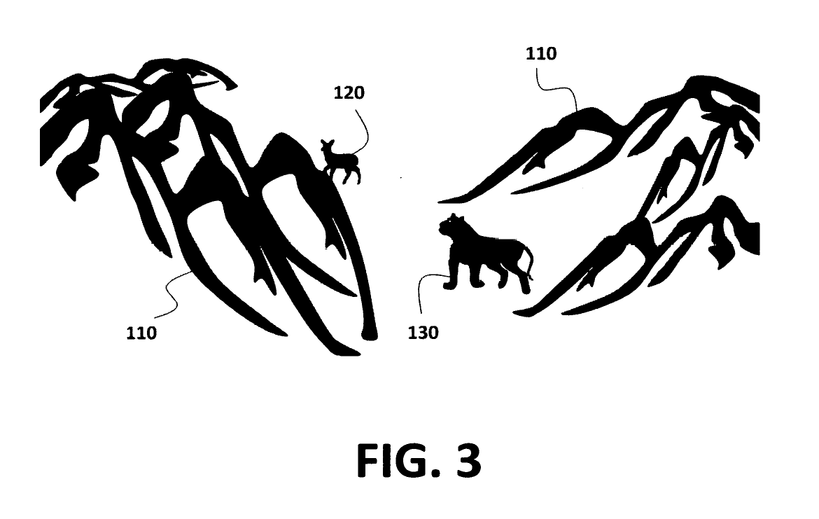

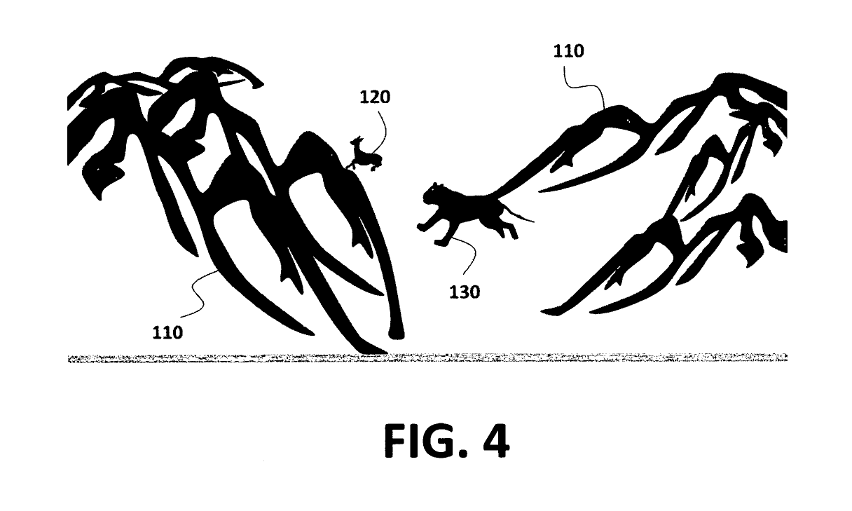

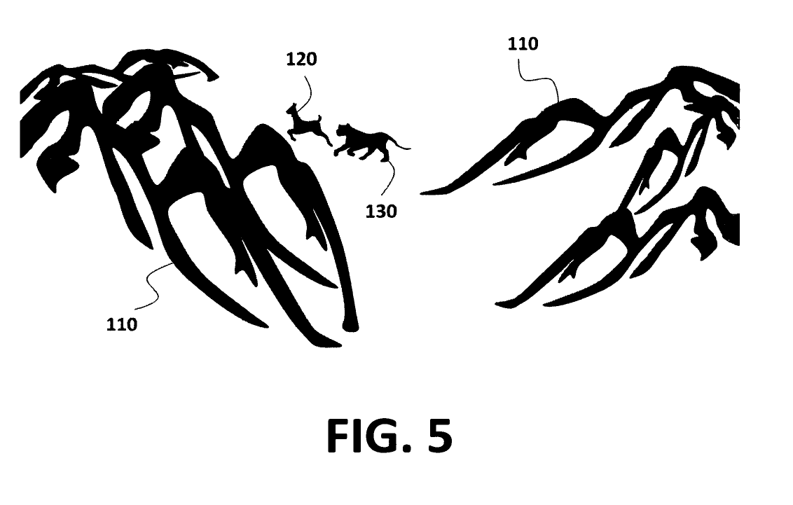

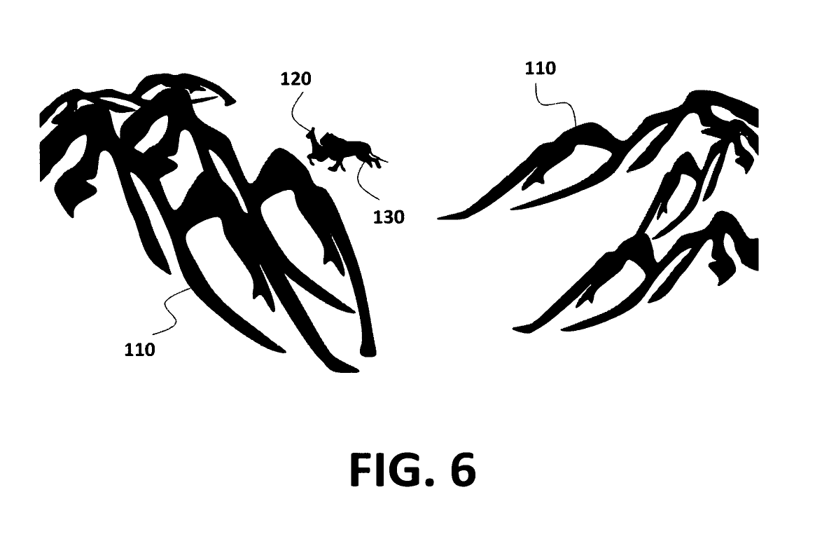

To clarify the method of the present invention, FIG. 1 illustrates a freehand drawing representing two mountains 110, a deer 120 and tiger 130. The scene is automatically converted into 3D models of the mountains, deer, and tiger. At this moment the tiger cannot see the deer. FIG. 2 illustrates the deer and tiger moving in random directions to achieve the “walk” desire of their first database. At a certain moment, the tiger sees the deer and starts attacking her as shown in FIGS. 3-5. The attacking of the tiger is to achieve the “attack” desire of his first database. The deer tries to escape from the tiger to achieve the “escape” desire of her first database. The lion runs towards the deer's position while the deer runs away from the lion's position. FIG. 6 illustrates the lion reaching the deer's position based on his speed relative to the deer's speed that are set within the parameters of their movement.

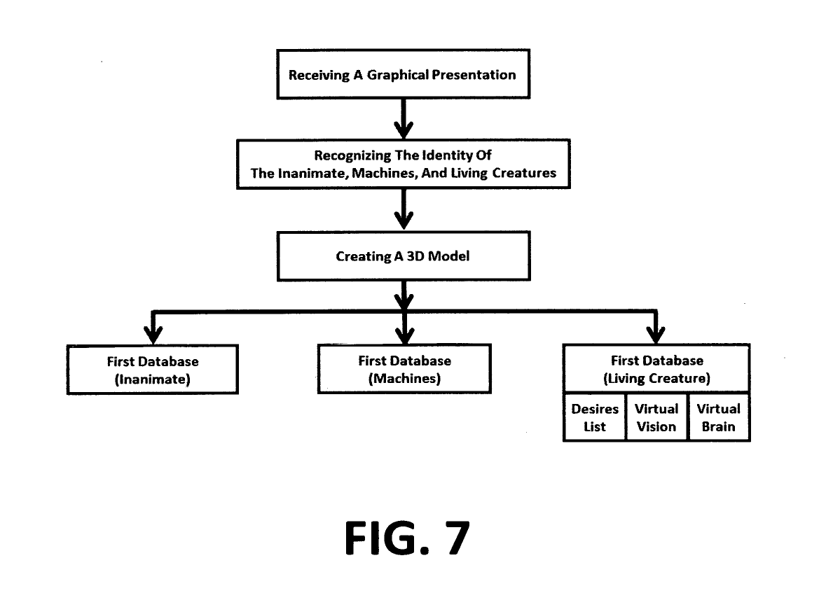

FIG. 7 is a block diagram illustrating the steps of the present invention according to one embodiment. As shown in the figure, the first step is to receive a graphical presentation including inanimate, machines, or living creatures. The second step is to recognize the identity of the inanimate, machines, or living creatures located in the graphical presentation. The third step is to create a 3D model representing the inanimate, machines, or living creatures of the graphical presentation. The fourth step is to access the first, second and third databases that successively define the movement of the inanimate, machines, and living creatures relative to each other. As shown in the block diagram, the third database includes the desires list, the virtual vision, and the virtual brain of the living creatures.

In one embodiment, in addition to the desire list, virtual vision and virtual brain, the third database includes a virtual memory which stores the previous experience of each living creature. For example, a deer who escaped a lion at a mountain will store this experience and may avoid walking again near this mountain. Also, a lion who failed to attack a deer by directly running behind her may go around a mountain to surprise and attack the deer in a new manner. Generally, the virtual memory simulates the individual experience of each living creature according to their previous experience in the same animation.

1. A computer animation method comprising:
receiving a graphical representation of two or more objects;
recognizing the identity of the two or more objects using a recognition computer program;
presenting 3D models of the two or more objects according to a first database that associates each unique identity with a 3D model; and
moving the 3D models relative to each other according to a second database that associates each identity with virtual desires, virtual vision and virtual brain that control the movement of the 3D models relative to each other.

2. The computer animation method of claim 1 wherein the identity represents an identity of an inanimate object, machine, or living creatures.

3. The computer animation method of claim 1 wherein the graphical representation is a two dimensional drawing drawn on a digital display of a mobile phone, tablet, or computer.

4. The computer animation method of claim 1 wherein the graphical representation is a freehand sketch drawn on a paper and captured by a digital camera.

5. The computer animation method of claim 1 wherein the graphical representation is 3D models of the two or more objects.

6. The computer animation method of claim 1 wherein the recognition computer program uses an artificial intelligence technique or deep learning technique to recognize the identity.

7. The computer animation method of claim 1 wherein the virtual desires represent a list of actions or movement of each identity towards other identities of the 3D models to simulate the real-life actions or movement.

8. The computer animation method of claim 1 wherein the virtual vision represents a list of vision limitations of each identity towards other identities of the 3D models to simulate the real-life vision ability.

9. The computer animation method of claim 1 wherein the virtual brain represents a list of rules to process the data of the list of actions and the data of the list of vision limitations to manage the movement of the 3D models relative to each other.

10. The computer animation method of claim 1 wherein the visual brain includes a virtual memory that stores the individual experience of each identity in the same animation wherein the data of the virtual memory impacts the list of rules which impacts the movement.

11. A computer method to automatically animate 3D models each of which represents a real-life object wherein the method comprising:
providing each 3D models with virtual desires in the form of a list of actions to simulate the real-life actions of the real-life object;
providing each 3D models with virtual vision in the form of a list of vision rules to simulate the real-life vision of the real-life object;
providing each 3D models with virtual brain in the form of a list of rules to process the data of the virtual desires and virtual vision, and manage the action or movement of each 3D model towards each other; and
providing each 3D model a virtual memory that stores the individual experience of each 3D model wherein the data of the virtual memory impacts the list of rules of the virtual brain.

12. The computer method of claim 11 wherein the 3D model represent inanimate objects, machines, or living creatures.

13. The computer method of claim 11 wherein the 3D models are automatically created from a two dimensional drawing drawn on a digital display of a mobile phone, tablet, or computer.

14. The computer method of claim 11 wherein the 3D models are automatically created from a freehand sketch drawn on a paper and captured by a digital camera.

15. The computer method of claim 11 wherein the 3D models are created by 3D software application.

16. The computer method of claim 11 wherein the actions are types of virtual movement to simulate the real-life movement of the real-life object;

17. The computer method of claim 11 wherein the vision limitation includes the distance of view, angle of view, and height of view.

18. The computer method of claim 11 wherein the virtual brain is a computer program assigned to each 3D model.

19. The computer method of claim 11 wherein the virtual memory impacts the movement of the 3D model towards each other based on the individual experience of each 3D model in the same animation.

20. The computer method of claim 19 wherein the virtual memory is a computer program utilizes an artificial intelligence technique.
